(19) United States
(12) Patent Application Publication
(10) Pub. No.: US 2026/0185583 A1
(43) Pub. Date: Jul. 2, 2026

(54) CYLINDER DEVICE

(71) Applicant: KYB Corporation, Tokyo (JP)

(72) Inventor: Yoshiki MATSUOKA, Tokyo (JP)

(73) Assignee: KYB Corporation, Tokyo (JP)

(21) Appl. No.: 19/129,672

(22) PCT Filed: Feb. 14, 2024
(86) PCT No.: PCT/JP2024/004933

§ 371 Date: May 14, 2025

(30) Foreign Application Priority Data
Mar. 10, 2023 (JP) 2023-037033

(51) Int. Cl. F16F 9/36; F16F 9/32; F16F 9/58

(52) U.S. Cl. CPC F16F 9/368; F16F 9/3235; F16F 9/585; F16F 2230/30

(57) ABSTRACT

The present invention includes a piston (3) that includes a piston main body (30) that is connected to a rod (2) inserted in a cylinder (1) movably in an axial direction and inserted in the cylinder (1) movably in the axial direction, and a piston ring (31) that is placed in an outer circumference of the piston main body (30), the cylinder (1) includes a stopper portion (10) of an annular shape that is formed by being caulked from an outer circumferential side, and comes into contact with an outer circumferential end on one end side of the piston main body (30) when the piston (3) moves to a stroke end in the cylinder (1), and an axial direction distance (W) between a side end of the piston in the axial direction of the stopper portion (10) and a portion that the piston main body (30) comes into contact with is shorter than an axial direction distance (L) between an end portion on a side of the stopper portion of a sliding surface (31a) of the piston ring (31) and an outer circumferential end of the piston main body (30).

### TECHNICAL FIELD

The present invention relates to a cylinder device.

### BACKGROUND ART

As a conventional cylinder device, for example, there is a shock absorber that is interposed between a vehicle body and an axle in a vehicle and suppresses vibration of the vehicle body and wheels by a damping force exerted at a time of extension and contraction.

Such a shock absorber includes a cylinder, a rod that is inserted into the cylinder movably in an axial direction, a piston that includes a piston main body that is inserted into the cylinder movably in the axial direction and is connected to the rod, and a piston ring that is placed in the outer circumference of the piston main body and comes slidably in contact with the inner circumference of the cylinder, and partitions the inside of the cylinder into an extension side chamber and a compression side chamber, and a damping passage that is provided to the piston main body, communicates the extension side chamber and the compression side chamber, and applies resistance to a flow of a passing liquid.

Since, in such a shock absorber, the rod only needs to have the length that makes it possible to secure a stroke volume required for the shock absorber mounted on the vehicle, the length of the rod may be made shorter than the length of the cylinder to reduce the weight of the shock absorber.

In such a shock absorber, for example, when the shock absorber is transported, an operator may push the rod into the cylinder to shorten the entire length of the shock absorber. However, it is concerned that, when the operator pushes the rod into the cylinder and erroneously pushes the entire rod into the cylinder, the rod may get into the cylinder and the liquid in the cylinder flows out to the outside.

Furthermore, in a case where a stopper is provided on an end side of the rod to prevent the rod from getting in the cylinder, there is a probability that the stopper interferes with a seal ring that seals the outer circumference of the rod and also causes an outflow of the liquid to the outside.

Hence, in a shock absorber disclosed in JP H9-53677 A, a stopper portion that the piston comes into contact with to regulate movement of a rod before the rod gets into a cylinder when an operator pushes the rod into the cylinder is provided to the inner circumference of the cylinder to prevent the rod from getting into the cylinder.

### CITATION LIST

### Patent Literature

Patent Literature 1: JP H 9-53677A

### SUMMARY OF INVENTION

### Technical Problem

This stopper portion is formed to have a circular arc shaped cross section by caulking the cylinder from the outer circumference. Furthermore, the end portion of the piston comes into contact with any portion from a distal end to a center top portion of the stopper portion to prevent the rod from getting into the cylinder.

However, in a case where the stopper portion is formed to have a circular arc shaped cross section, an end portion of the piston ring facing the stopper side may contact a portion of the stopper portion that comes into contact with the piston before the piston main body of the piston comes into contact with the stopper portion. Then, the piston ring gets on the distal end side of the stopper portion, and the piston ring is caught between the piston main body and the stopper portion, which may cause problems that, for example, the piston ring deteriorates or the piston is fixed to the cylinder and cannot move.

It is therefore an object of the present invention to provide a cylinder device in which, even when a stopper portion formed by caulking a cylinder from the outer circumferential side is provided at the inner circumference of the cylinder, a piston ring is not concerned to be caught between a piston main body and the stopper portion.

### Solution to Problem

To solve the above-described problems, a cylinder device according to the present invention includes a piston including a piston main body that is connected to a rod inserted in a cylinder movably in an axial direction and inserted in the cylinder movably in the axial direction, and a piston ring that is placed in an outer circumference of the piston main body and comes slidably in contact with an inner circumference of the cylinder, the cylinder includes a stopper portion that is formed by being caulked from an outer circumferential side and protrudes toward an inner circumferential side of the cylinder, and comes into contact with an outer circumferential end on one end side of the piston main body when the piston moves to a stroke end in one direction in the cylinder, and an axial direction distance between a side end of the piston in the axial direction of the stopper portion and a portion of the stopper portion that the piston main body comes into contact with is shorter than an axial direction distance between an end portion on a side of the stopper portion of a sliding surface of the piston ring that comes slidably in contact with the inner circumference of the cylinder, and the outer circumferential end of the piston main body. According to this configuration, when the outer circumferential end on the one end side of the piston main body comes into contact with the stopper portion, the end on the stopper portion side of the sliding surface of the piston ring is separated from the piston side end in the axial direction of the stopper portion, so that the piston ring does not get on the stopper.

### BRIEF DESCRIPTION OF DRAWINGS

FIG. 1 is a cross-sectional view of a shock absorber according to the present embodiment.

FIG. 2 is a cross-sectional view illustrating part of the enlarged shock absorber according to the present embodiment.

FIG. 3 (A) is a view for explaining a processing procedure of placing a piston ring in an outer circumference of a piston main body of the shock absorber according to the present embodiment. FIG. 3 (B) is a view for explaining a state where a base material is pushed into the inner circumference of a die at a time of a process of placing the piston ring in the outer circumference of the piston main body of the shock absorber according to the present embodiment.

### DESCRIPTION OF EMBODIMENTS

Hereinafter, a shock absorber D that is a cylinder device according to the present invention will be described with reference to the drawings. The same reference signs throughout the several drawings indicate the same part. Furthermore, upper and lower directions in a state where the shock absorber D is installed in a vehicle are simply referred to as “upper” or “up” and “lower” or “down”, respectively, or referred to as “vertically”, unless otherwise specified.

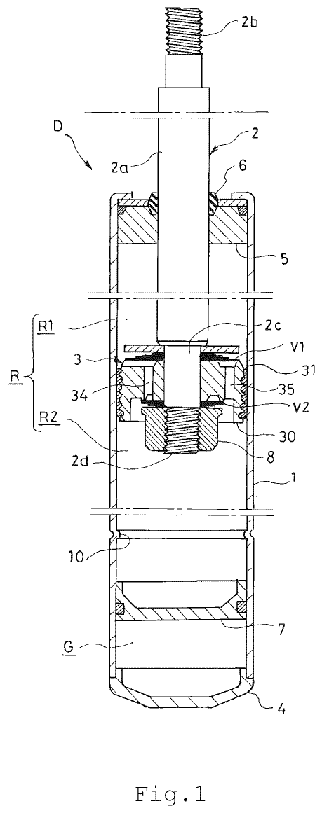

As illustrated in FIG. 1, the shock absorber D according to the present embodiment includes a cylinder 1, a rod 2 that is inserted into the cylinder 1 movably in an axial direction, and a piston 3 that includes a piston main body 30 that is inserted in the cylinder 1 movably in the axial direction and connected to the rod 2, and a piston ring 31 that is placed in the outer circumference of the piston main body 30 and comes slidably in contact with the inner circumference of the cylinder 1, and the cylinder 1 includes a stopper portion 10 that is formed by being caulked from an outer circumferential side and protrudes toward an inner circumferential side of the cylinder 1, and comes into contact with one end of the piston main body 30 when the piston 3 moves to a stroke end in a lower direction in the cylinder 1. Note that, although the shock absorber D is an upright type in which the rod 2 is connected to a vehicle body side and the cylinder 1 is connected to an axle side in the present embodiment, the shock absorber D may be an inverted type in which the cylinder 1 is connected to the vehicle body side and the rod 2 is connected to the axle side.

Hereinafter, each portion of the shock absorber D according to the present embodiment will be described in detail. In the shock absorber according to the present embodiment, a free piston 7 that comes slidably in contact with the inner circumference of the cylinder 1 and partitions the inside of the cylinder 1 into a liquid chamber R and a gas chamber G is provided on the lower side in FIG. 1 in the cylinder 1, and the liquid chamber R is partitioned into an extension side chamber R1 and a compression side chamber R2 by the piston 3 to be slidably inserted into the cylinder 1. Furthermore, the extension side chamber R1 and the compression side chamber R2 are filled with a liquid such as a hydraulic oil, and the inside of the gas chamber G is filled with an inert gas such as nitrogen. In this regard, as the liquid to be filled in the extension side chamber RI and the compression side chamber R2, for example, a liquid such as water or an aqueous solution can be used in addition to the hydraulic oil. Furthermore, the inside of the gas chamber G may be filled with a gas other than the inert gas.

The cylinder 1 includes a lower end in FIG. 1 that is closed by a bottom cap 4, and an upper end in FIG. 1 at which a rod guide 5 of an annular shape that axially supports the rod 2 slidably is mounted. Furthermore, a seal member 6 that comes slidably in contact with the outer circumference of the rod 2 is mounted at the upper end of the cylinder 1 in FIG. 1 and above the rod guide 5 in FIG. 1. This seal member 6 seals the outer circumference of the rod 2 to prevent leakage of the liquid in the cylinder 1.

Note that the rod 2 includes a main body portion 2a that comes slidably in contact with the seal member 6 and gets in and gets out of the cylinder 1, and a connecting portion 2b that has the smaller outer diameter than that of the main body portion 2a and is connectable to a vehicle or the like above the main body portion 2a.

As illustrated in FIG. 1, the piston 3 includes the piston main body 30 of an annular shape, and the piston ring 31 of a tubular shape that is made of a synthetic resin and placed in the outer circumference of the piston main body 30.

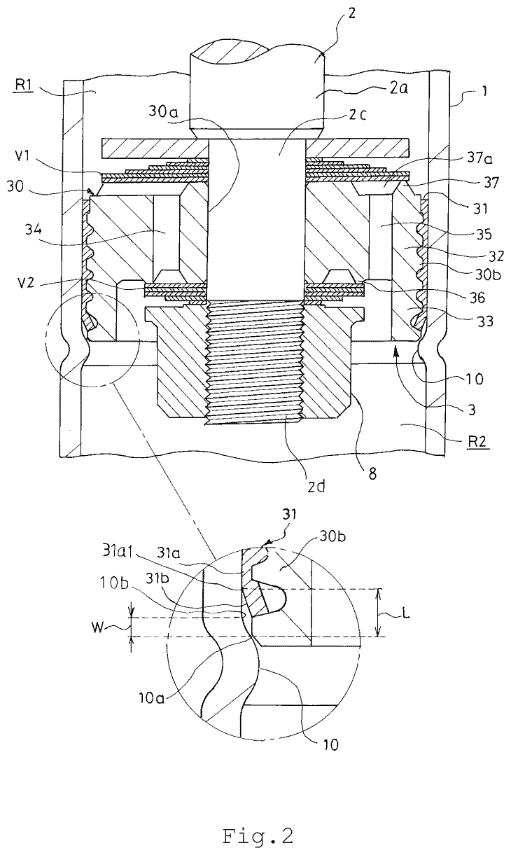

As illustrated in FIG. 2, the piston main body 30 includes a disk portion 32 of the annular shape in which an attachment hole 30a is formed at the center, a skirt portion 33 of an annular shape that extends from the outer circumference of the disk portion 32 to the lower side in FIG. 1 along the axial direction, a plurality of extension side ports 34 and a plurality of compression side ports 35 that penetrate the disk portion 32 in the axial direction, an extension side valve seat 36 of an annular shape that is provided at the lower end of the disk portion 32 in FIG. 1 and on the inner side of the skirt portion 33, and a petal-shaped compression side valve seat 37 that is provided at the upper end of the disk portion 32 in FIG. 1.

Furthermore, the compression side port 35 includes an inlet end that is opened toward the outer side of the extension side valve seat 36 at the lower end of the disk portion 32 in FIG. 1, and an outlet end that is opened through an independent opening window 37a surrounded by the compression side valve seat 37 at the upper end of the disk portion 32 in FIG. 1 to communicate the extension side chamber R1 and the compression side chamber R2.

Furthermore, the extension side port 34 includes an inlet end that is opened from a portion that is not surrounded by the compression side valve seat 37 at the upper end of the disk portion 32 in FIG. 1, and an outlet end that is opened toward the inner side of the extension side valve seat 36 at the lower end of the disk portion 32 in FIG. 1, and communicates the extension side chamber R1 and the compression side chamber R2.

Furthermore, at the upper end of the piston 3 in FIG. 1 facing the extension side chamber R1, compression side leaf valves V1 of annular shapes that are seated on the compression side valve seat 37 are stacked, and, at the lower end of the piston 3 in FIG. 1 facing the compression side chamber R2, extension side leaf valves V2 of annular shapes that are seated on the extension side valve seat 36 are stacked.

Furthermore, in a state where the compression side leaf valves V1 and the extension side leaf valves V2 are stacked in the piston 3, the compression side leaf valves V1 and the extension side leaf valves V2 are assembled to the outer circumference of a piston mounting portion 2c having a small diameter and provided at the distal end of the main body portion 2a of the rod 2, then a piston nut 8 is mounted to and tightened in a screw portion 2d at the distal end of the piston mounting portion 2c, and thereby the piston 3, the compression side leaf valves V1, and the extension side leaf valves V2 are fixed to the rod 2.

When the piston 3, the compression side leaf valves V1, and the extension side leaf valves V2 are fixed to the rod 2 as described above, the compression side leaf valves V1 and the extension side leaf valves V2 have the inner circumferences fixed to the rod 2 thereof while bending of the outer circumferences thereof is allowed.

In a state where the compression side leaf valves V1 are seated on the compression side valve seat 37, the compression side leaf valves V1 close the compression side ports 35, open the compression side ports 35 when the outer circumferential side bends, and consequently can open and close the compression side ports 35. Furthermore, in a state where the extension side leaf valves V2 are seated on the extension side valve seat 36, the extension side leaf valves V2 close the extension side ports 34, open the extension side ports 34 when the outer circumferential side bends, and consequently can open and close the extension side ports 34.

Furthermore, the outer circumferences of the disk portion 32 and the skirt portion 33 that are the outer circumference of the piston main body 30 are provided with a piston ring mounting portion 30b including the plurality of annular grooves along the circumferential direction.

The piston ring 31 is pressed against and placed in the piston ring mounting portion 30b in a heated state, thereby the inner circumference is deformed into a shape matching with the piston ring mounting portion 30b, and the piston ring 31 is integrated with the piston main body 30.

Next, an operation of the shock absorber D according to the present embodiment will be described in detail. First, when the piston 3 moves downward in FIG. 1 in the cylinder 1 and the shock absorber D contracts, while the extension side leaf valves V2 are pressed toward the piston 3 side by the pressure of the compression side chamber R2 that is compressed and increases to close the extension side ports 34, the compression side leaf valves VI that receive the pressure of the compression side chamber R2 via the compression side ports 35 bend and separate from the compression side valve seat 37 to open the compression side ports 35. The compression side leaf valves V1 apply resistance to the flow of the liquid passing through the compression side ports 35 and moving from the compression side chamber R2 to the extension side chamber R1, so that the shock absorber D exerts a compression side damping force that prevents contraction of the shock absorber D.

On the contrary, when the piston 3 moves upward in FIG. 1 in the cylinder 1 and the shock absorber D extends, while the compression side leaf valves VI are pressed toward the piston 3 side by the pressure of the extension side chamber R1 that is compressed and increases to close the compression side ports 35, the extension side leaf valves V2 that receive the pressure of the extension side chamber R1 via the extension side ports 34 bend and separate from the extension side valve seat 36 to open the extension side ports 34. The extension side leaf valves V2 apply resistance to the flow of the liquid passing through the extension side ports 34 and moving from the extension side chamber R1 to the compression side chamber R2, so that the shock absorber D exerts an extension side damping force that prevents extension of the shock absorber D.

Furthermore, the volume of the rod 2 that gets in and gets out of the cylinder 1 is absorbed when the free piston 7 moves in the cylinder 1 and compresses or expands the gas chamber G. As described above, the shock absorber D according to the present embodiment is a monotube shock absorber, but may be configured as a so-called dual tube shock absorber in which a base valve is provided at the lower end of the cylinder 1 and a reservoir is provided outside the cylinder.

Next, the stopper portion 10 provided to the cylinder 1 will be described in detail. The stopper portion 10 is formed in an annular shape so as to protrude toward the inner circumferential side of the cylinder 1 by caulking the cylinder 1 from the outer circumferential side. Furthermore, as illustrated in FIG. 2, when the piston 3 moves to the stroke end on the lower side in the cylinder 1, an outer circumferential end on a lower end side of the piston main body 30 comes into contact with the stopper portion 10 to regulate the piston 3 from moving to the lower side in the axial direction.

Here, the stopper portion 10 is provided at a position equal to or lower than a lower limit position that is a maximum stroke position on a contraction side of the shock absorber D in a stroke range of the piston 3 required for the shock absorber D mounted on the vehicle.

Furthermore, in a case where the stopper portion 10 is provided at the lower limit position of the piston 3, the stopper portion 10 can regulate the outer circumferential end on the lower end side of the piston main body 30 from coming into contact with the stopper portion 10 at a time of maximum contraction of the shock absorber D and contracting the shock absorber D more while allowing the stroke of the piston 3 required for the shock absorber D mounted on the vehicle. Furthermore, in a case where the stopper portion 10 is provided below the lower limit position of the piston 3, the stopper portion 10 does not interfere with the piston 3 when the shock absorber D extends and contracts within a required range and exerts a damping force while allowing the stroke of the piston 3 required for the shock absorber D mounted on the vehicle.

Furthermore, in the present embodiment, the stopper portion 10 is provided at a position outside the stroke range of the free piston 7, and consequently does not interfere with the free piston 7, either.

Note that, in a case where the shock absorber D is configured as a so-called dual tube shock absorber in which the base valve is provided at the lower end of the cylinder 1 and the reservoir is provided outside the cylinder, the stopper portion 10 is provided above the base valve of the cylinder 1, so that the stopper portion 10 can prevent the piston 3 from contacting the base valve.

Furthermore, the stopper portion 10 is provided at such a position at which, when the shock absorber D is pushed and contracted to push the rod 2 into the cylinder 1, the outer circumferential end on the lower end side of the piston main body 30 comes into contact with the stopper portion 10 before the entire main body portion 2a of the rod 2 enters the cylinder 1. Accordingly, the stopper portion 10 according to the present embodiment regulates the outer circumferential end on the lower end side of the piston 3 from coming into contact with the stopper portion 10 before the main body portion 2a of the rod 2 gets into the cylinder 1, and regulates the piston 3 from moving toward the lower side in the axial direction, and consequently can prevent the main body portion 2a of the rod 2 from getting into the cylinder 1.

Furthermore, although not illustrated, the outer circumference of the upper end of the main body portion 2a of the rod 2 may be provided with a large-diameter portion made of a collar or the like for attaching a bump cushion or the like to the outer circumference of the upper end of the rod 2. In such a case, when the main body portion 2a of the rod 2 gets into the cylinder 1, the large-diameter portion of the rod 2 is concerned to contact the seal member 6 disposed above the rod guide 5 and damage the seal member 6. By contrast with this, in the present embodiment, as described above, before the main body portion 2a of the rod 2 gets into the cylinder 1, the outer circumferential end on the lower end side of the piston 3 comes into contact with the stopper portion 10 to regulate the piston 3 from moving to the lower side in the axial direction, so that it is possible to prevent the seal member 6 from being damaged.

More specifically, as illustrated in FIG. 2, the stopper portion 10 is formed to have the circular arc shaped cross section by caulking the cylinder 1 from the outer circumferential side. Furthermore, when the piston 3 moves to the stroke end on the lower side in the cylinder 1, the outer circumferential end on the lower end side of the piston main body 30 comes into contact with an intermediate portion (contact portion 10a) at the center top portion from an upper end 10b of the stopper portion 10 to regulate the piston 3 from moving in the lower direction. However, the position of the contact portion 10a changes depending on the curvature radius of the stopper portion 10 and the shape of the outer circumferential end on the lower end side of the piston main body 30, and therefore is not limited to the middle of the center top portion from the upper end 10b of the stopper portion 10, and any portion of the center top portion from the upper end 10b of the stopper portion 10 is the contact portion 10a.

Furthermore, as illustrated in FIG. 2, an axial direction distance W between the upper end 10b (piston 3 side end) of the stopper portion 10 and the contact portion 10a that is the portion of the stopper portion 10 that the piston main body 30 comes into contact with is set to be shorter than an axial direction distance I between a lower end 31a1 (stopper portion 10 side end portion) of a sliding surface 31a of the piston ring 31 that comes slidably in contact with the inner circumference of the cylinder 1, and the outer circumferential end (a portion that comes into contact with the contact portion 10a of the stopper portion 10) on the lower end side of the piston main body 30.

Here, the axial direction distance W between the upper end 10b and the contact portion 10a of the stopper portion 10 refers to a distance between an extension line extending in a radial direction from the upper end 10b of the stopper portion 10, and an extension line extending in the radial direction from the contact portion 10a of the stopper portion 10. Furthermore, the axial direction distance L between the lower end 31a1 of the sliding surface 31a of the piston ring 31 that comes slidably in contact with the inner circumference of the cylinder 1, and the outer circumferential end on the lower end side of the piston main body 30 refers to a distance between an extension line extending in the radial direction from the lower end 31a1 of the sliding surface 31a of the piston ring 31, and an extension line extending in the radial direction from the outer circumferential end on the lower end side of the piston main body 30.

As described above, in a case where the axial direction distance W between the upper end 10b and the contact portion 10a of the stopper portion 10 is set to be shorter than the axial direction distance L between the lower end 31a1 of the sliding surface 31a of the piston ring 31 that comes slidably in contact with the inner circumference of the cylinder 1, and the outer circumferential end on the lower end side of the piston main body 30, when the outer circumferential end on the lower end side of the piston main body 30 comes into contact with the stopper portion 10 as illustrated in FIG. 2, the lower end 31a1 of the sliding surface 31a of the piston ring 31 is separated from the upper end 10b of the stopper portion 10.

Therefore, the piston ring 31 can be prevented from getting on the upper end 10b side of the stopper portion 10 and being caught between the piston main body 30 and the stopper portion 10, so that problems that the piston ring 31 is deteriorated and the piston 3 is fixed to the cylinder 1 and cannot move do not occur.

Note that, although the stopper portion 10 is formed by roll-caulking the cylinder 1 from the outer circumferential side in the present embodiment, the stopper portion may be formed by a caulking method other than roll caulking such as multi-point caulking of caulking the cylinder 1 at a plurality of points in the circumferential direction. In a case where the stopper portion is formed by multi-point caulking, at least two stopper portions may be provided.

However, in a case where the stopper portion is formed by multi-point caulking, if the axial direction position of a caulked point is shifted in the circumferential direction, when the outer circumferential end on the lower end side of the piston main body 30 comes into contact with the stopper portion, there are formed a portion at which the stopper portion comes into contact with the piston main body 30, and a portion at which the stopper portion does not come into contact with, By contrast with this, in the case where the stopper portion 10 is formed by roll caulking as in the present embodiment, the axial direction position of the stopper portion 10 is aligned in the circumferential direction, so that, when the outer circumferential end on the lower end side of the piston main body 30 comes into contact with the stopper portion 10, the entire stopper portion 10 can support the piston main body 30. Consequently, when the stopper portion 10 is formed by roll caulking, the load resistance of the stopper portion 10 improves.

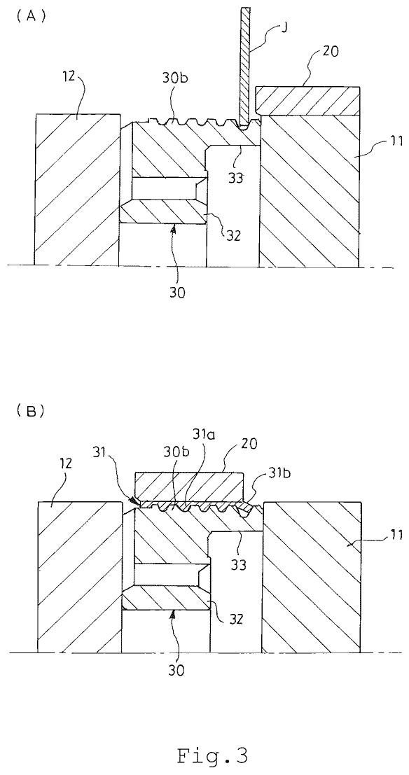

Furthermore, in a state where a base material J of a disk shape made of a synthetic resin is fitted in the annular grooves disposed on one end side of the piston ring mounting portion 30b provided at the outer circumference of the piston main body 30 as illustrated in FIG. 3(A), the piston main body 30 is pushed into the die 20 of a tubular shape from the one end side as illustrated in FIG. 3(B) to place the piston ring 31 in the outer circumference of the piston main body 30.

More specifically, when the piston ring 31 is placed in the outer circumference of the piston main body 30, first, in a state where the piston main body 30 is sandwiched and fixed by fixing jigs 11 and 12 as illustrated in FIG. 3(A), the base material J of the disk shape that becomes the piston ring 31 and is made of the synthetic resin is fitted into the annular grooves disposed on one end side of the piston ring mounting portion 30b.

Next, as illustrated in FIG. 3(B), the die 20 of the tubular shape installed on the fixing jig 11 in contact with one end side of the piston main body 30 is moved toward the other end side of the piston main body 30, and the base material J that is heated and becomes easy to deform is pushed into the die 20 of the tubular shape from the one end side of the piston main body 30 together with the base material J. Although the inner diameter of the die 20 is larger than the outer diameter of the piston main body 30, a gap between the die 20 and the piston main body 30 is narrower than the thickness of the base material J.

Furthermore, the base material J is heated and softened and therefore is stripped by the die 20 as the volume of the piston main body 30 entering the die 20 increases, and is pressed against the piston ring mounting portion 30b from the outer circumference by the die 20.

Then, the inner circumference of the base material J is deformed so as to enter the annular grooves along the outer circumferential shape of the piston ring mounting portion 30b, and is firmly fixed to the piston main body 30.

As described above, when the piston main body 30 is pushed into the die 20 of the tubular shape from the one end side in a state where the base material J is fitted into the annular grooves disposed on the one end side of the piston ring mounting portion 30b provided at the outer circumference of the piston main body 30, the one end of the piston ring 31 is pressed against the annular grooves of the piston ring mounting portion 30b by the die 20, and thus becomes an inclined portion 31b that is inclined inward. Therefore, as illustrated in FIG. 2, the piston ring 31 placed in the outer circumference of the piston main body 30 includes a sliding surface 31a of a tubular shape that comes slidably in contact with the inner circumference of the cylinder 1, and the inclined portion 31b that continues to the lower end 31a1 of the sliding surface 31a and is inclined inward.

Furthermore, the inclined portion 31b of the piston ring 31 does not come slidably in contact with the inner circumference of the cylinder 1, so that, by connecting the piston 3 to the rod 2 such that the inclined portion 31b faces the lower side (the stopper portion 10 side) as illustrated in FIG. 2, it is possible to secure by the axial direction length of the inclined portion 31b the axial direction distance L between the lower end 31a1 of the sliding surface 31a of the piston ring 31 and the outer circumferential end on the lower end side of the piston main body 30.

Consequently, it is easy to set the axial direction distance I between the lower end 31a1 of the sliding surface 31a of the piston ring 31 and the outer circumferential end on the lower end side of the piston main body 30 longer than the axial direction distance W between the upper end 10b and the contact portion 10a of the stopper portion 10.

Note that the piston ring 31 may be placed in the outer circumference of the piston 3 such that the inclined portion 31b continues to the upper end of the sliding surface 31a. In this regard, even in such a case, it is necessary to set the axial direction distance L between the lower end 31a1 of the sliding surface 31a of the piston ring 31 and the outer circumferential end on the lower end side of the piston main body 30 longer than the axial direction distance W between the upper end 10b and the contact portion 108 of the stopper portion 10, so that a positional relationship in the axial direction between the lower end 31a1 of the sliding surface 31a of the piston ring 31 and the outer circumferential end on the lower end side of the piston main body 30 is not different from that in the present embodiment. That is, even if the inclined portion 31b continuing to the lower end of the sliding surface 31a is removed from the piston ring 31 according to the present embodiment, the axial direction length of the piston main body 30 cannot be shortened.

Furthermore, in a case where the axial direction length of the sliding surface 31a is the same as that in the present embodiment, when the inclined portion 31b is continued to the upper end of the sliding surface 31a, it is necessary to additionally provide a mounting portion for mounting the inclined portion 31b to the piston main body 30, and therefore the axial direction length of the piston main body 30 is longer than that of the piston main body 30 according to the present embodiment by the length of the mounting portion.

That is, although the piston ring 31 can be attached to the outer circumference of the piston 3 such that the inclined portion 31b continues to the upper end of the sliding surface 318, as in the present embodiment, placing the piston ring 31 in the outer circumference of the piston 3 such that the inclined portion 31b continues to the lower end of the sliding surface 31a can shorten the axial direction length of the piston main body 30.

Furthermore, the method for placing the piston ring 31 in the outer circumference of the piston main body 30 is not limited to the above-described method, and, for example, the piston ring may have a tubular shape having a crack, and the crack may be pushed wide to place the piston ring in the outer circumference of the piston main body 30.

As described above, the shock absorber D that is the cylinder device according to the present embodiment includes the cylinder 1, the rod 2 that is inserted into the cylinder 1 movably in the axial direction, and the piston 3 that includes the piston main body 30 that is inserted in the cylinder 1 movably in the axial direction and connected to the rod 2, and the piston ring 31 that is placed in the outer circumference of the piston main body 30 and comes slidably in contact with the inner circumference of the cylinder 1, and the cylinder 1 includes the stopper portion 10 of the annular shape that is formed by being caulked from the outer circumferential side and protrudes toward the inner circumferential side of the cylinder 1, and comes into contact with the outer circumferential end on the lower end side of the piston main body 30 when the piston 3 moves to the stroke end in the lower direction in the cylinder 1, and the axial direction distance W between the upper end 10b (piston side end) in the axial direction of the stopper portion 10, and the contact portion 10a that is the portion of the stopper portion 10 that the piston main body 30 comes into contact with is shorter than the axial direction distance L between the lower end 31a1 (stopper portion 10 side end portion) of the sliding surface 31a of the piston ring 31 that comes slidably in contact with the inner circumference of the cylinder 1, and the outer circumferential end of the piston main body 30.

According to this configuration, when the outer circumferential end on the lower end side of the piston main body 30 comes into contact with the stopper portion 10, the lower end 31a1 of the sliding surface 31a of the piston ring 31 is separated from the upper end 10b of the stopper portion 10.

Consequently, the piston ring 31 can be prevented from getting on the upper end 10b side of the stopper portion 10 and being caught between the piston main body 30 and the stopper portion 10, so that problems that the piston ring 31 is deteriorated and the piston 3 is fixed to the cylinder 1 and cannot move do not occur.

Furthermore, as described above, in the present embodiment, the stopper portion 10 is provided at the position of the stroke end on the lower side of the piston 3 that is the position equal to or lower than the lower limit position that is the maximum stroke position on the contraction side of the shock absorber D in the stroke range of the piston 3 required for the shock absorber D mounted on the vehicle to regulate the piston 3 from moving in the lower direction. In this regard, the stopper portion 10 may be provided at a position of the stroke end on the upper side of the piston 3 that is a position equal to or higher than an upper limit position that is a maximum stroke position on the extension side of the shock absorber D in the stroke range of the piston 3 required for the shock absorber D mounted on the vehicle to regulate the piston 3 from moving in the upper direction. By so doing, even if the rod 2 is pulled from a state where the piston is at the upper limit position, the piston 3 is regulated from moving before the piston 3 hits the rod guide 5, so that, in a case where a seal is provided at the inner circumference of the rod guide 5 although not illustrated, it is possible to prevent the piston 3 from damaging the seal.

Furthermore, in the shock absorber D according to the present embodiment, the piston ring mounting portion 30b including the plurality of annular grooves along the circumferential direction is provided at the outer circumference of the piston main body 30, and the piston ring 31 is placed in the outer circumference of the piston main body 30 by pushing the piston main body 30 into the die 20 of the tubular shape from the one end side in the state where the base material J of the disk shape made of the synthetic resin is fitted to the annular grooves disposed on the one end side of the piston ring mounting portion 30b.

The one end of the piston ring 31 placed as described above is the inclined portion 31b inclined inward, so that, by connecting the piston 3 to the rod 2 such that this inclined portion 31b faces the stopper portion 10 side, it is possible to secure by the axial direction length of the inclined portion 31b the longer axial direction distance L between the stopper portion 10 side end (lower end 31a1) of the sliding surface 31a of the piston ring 31 and the outer circumferential end on the one end side of the piston main body 30.

Consequently, according to the above configuration, it is easy to set the axial direction distance L between the stopper portion 10 side end of the sliding surface 31a of the piston ring 31 and the outer circumferential end on the one end side of the piston main body 30 longer than the axial direction distance W between the piston 3 side end (upper end 10b) in the axial direction of the stopper portion 10 and the portion (contact portion 10a) of the stopper portion 10 that the piston main body 30 comes into contact with.

Note that, although the inclined portion 31b of the piston ring 31 is formed when the base material J of the disk shape is pushed into the die 20 of the tubular shape and the piston ring 31 is placed in the outer circumference of the piston main body 30 in the present embodiment, the inclined portion 31b may be formed by any method.

Even if the inclined portion 31b is formed by any method, as long as the piston ring 31 includes the inclined portion 31b inclined inward from the end portion on the stopper portion 10 side of the sliding surface 31a, it is possible to secure by the axial direction length of the inclined portion 31b the longer axial direction distance L between the stopper portion 10 side end (lower end 31a1) of the sliding surface 31a of the piston ring 31 and the outer circumferential end on the one end side of the piston main body 30.

Consequently, it is easy to set the axial direction distance L between the stopper portion 10 side end of the sliding surface 31a of the piston ring 31 and the outer circumferential end on the one end side of the piston main body 30 longer than the axial direction distance W between the piston 3 side end (upper end 10b) in the axial direction of the stopper portion 10 and the portion (contact portion 10a) of the stopper portion 10 that the piston main body 30 comes into contact with.

Furthermore, the method for placing the piston ring 31 in the outer circumference of the piston main body 30 is not limited to the above-described method, and, for example, the piston ring may have a tubular shape having a crack, and the crack may be pushed wide to place the piston ring in the outer circumference of the piston main body 30.

Note that, although the cylinder device according to the present invention is the shock absorber D in the present embodiment, the cylinder device according to the present invention may be, for example, a gas spring.

Although the preferred embodiment of the present invention has been described above in detail, modifications, variations, and changes are possible without departing from the scope of the claims.

### REFERENCE SIGNS LIST

1 cylinder
2 rod
3 piston
10 stopper portion
10b upper end of stopper portion (piston side end of stopper portion)
20 die
30 piston main body
30b piston ring mounting portion
31 piston ring
31a sliding surface
31a1 lower end of sliding surface (end portion on stopper portion side of sliding surface)
31b inclined portion
D shock absorber (cylinder device)
J base material

1. A cylinder device comprising:
a cylinder;
a rod that is inserted into the cylinder movably in an axial direction; and
a piston that includes a piston main body that is inserted in the cylinder movably in the axial direction and connected to the rod, and a piston ring that is placed in an outer circumference of the piston main body and comes slidably in contact with an inner circumference of the cylinder, wherein
the cylinder includes a stopper portion that is formed by being caulked from an outer circumferential side and protrudes toward an inner circumferential side of the cylinder, and comes into contact with an outer circumferential end on one end side of the piston main body when the piston moves to a stroke end in one direction in the cylinder, and
an axial direction distance between a side end of the piston in the axial direction of the stopper portion and a portion of the stopper portion that the piston main body comes into contact with is shorter than an axial direction distance between an end portion on a side of the stopper portion of a sliding surface of the piston ring that comes slidably in contact with the inner circumference of the cylinder, and the outer circumferential end of the piston main body.

2. The cylinder device according to claim 1, wherein
the outer circumference of the piston main body is provided with a piston ring mounting portion including a plurality of annular grooves along a circumferential direction, and
the piston ring is placed in the outer circumference of the piston main body by pushing the piston main body into a die of a tubular shape from one end side in a state where a base material of a disk shape made of a synthetic resin is fitted in the annular grooves disposed on one end side of the piston ring mounting portion.

3. The cylinder device according to claim 1, wherein the piston ring includes an inclined portion that is inclined inward from the end portion on the side of the Stopper portion of the sliding surface.
